(19) United States
(12) Patent Application Publication
(10) Pub. No.: US 2023/0267399 A1
(43) Pub. Date: Aug. 24, 2023

(54) SYSTEM AND METHOD FOR PROVIDING A DRIVER OF A VEHICLE WITH FEEDBACK FOR SELF-COACHING

(71) Applicant: Bendix Commercial Vehicle Systems LLC, Avon, OH (US)

(72) Inventors: Shaun M. Howard, Irvine, CA (US); William Morgan, Crystal Lake, IL (US); Hans M. Molin, Mission Viejo, CA (US)

(21) Appl. No.: 17/675,634

(22) Filed: Feb. 18, 2022

(51) Int. Cl. G06Q 10/06; G06F 16/2457; G06F 16/248; B60K 35/00; G09B 19/16

(52) U.S. Cl. CPC G06Q 10/06398; B60K 35/00; G06F 16/24578; G06F 16/248; G09B 19/167; B60K 2370/152; B60K 2370/16

(57) ABSTRACT

A method of providing a driver of a vehicle with feedback for self-coaching, via a driver electronic device includes querying a server from access software on the driver electronic device, wherein the querying comprises querying the server with a query comprising a predefined driver; receiving, by the access software, driver coaching data associated with the predefined driver, the driver coaching data being based on an output from an active safety system on the vehicle; listing, by the access software, a user-selectable item representing the received driver coaching data via a display of the driver electronic device; and conveying the driver coaching data to the driver.

### BACKGROUND

The present invention relates to improving performance of vehicle drivers. It finds particular application in conjunction with providing opportunities for vehicle drivers to self-coach and will be described with particular reference thereto. It will be appreciated, however, that the invention is also amenable to other applications.

Many businesses have employees and/or representatives who drive on behalf of the employer. Because driving employees and/or representatives are essentially an extension of their employer, it is a particular concern to make sure the drivers are driving safely. For example, unsafe actions by employees and/or representatives while driving create high potential for liability to the employer. Further, safe and courteous driving is also something that reflects on the employer when third parties can ascertain, from the vehicle driven, the identity of their employer. The same issues arise with commercial carriers who employ drivers of large trucks and other heavy vehicles.

As a consequence of liability, legal requirements, and insurance requirements, businesses, government agencies, and commercial carriers have initiated programs for increasing safety and reducing accidents by their employees and/or representatives who drive. Such programs generally have an ultimate goal of reducing accidents and injuries caused by poor or unsafe driving habits of employed drivers.

However, such programs are less than effective because they generally are based on information collected on driving employees, after an unsafe or discourteous driving event has occurred, and then reported to the employer. Reviewing the driving habits of employees on an ongoing basis is at best problematic, as it is based on the few reports of unsafe and problematic drivers, where third parties might take the time to do so.

Further, an issue arises in the hiring of employees in determining new employees’ ability to drive safely and courteously. Currently, if any review is done on new drivers, it is by obtaining their driving record from a motor vehicle department, which may list past infractions. However, many drivers who receive driving infraction tickets are able to have them removed from their record by attending traffic school or the like. Further, it is not unknown that a new employee will have a license in a new state, and their prior record in a different state will go unnoticed.

Even where employers attempt some sort of ongoing driver monitoring and educational program, such are usually a generic or generalized approach to safety and education for their drivers on an ongoing basis. Such programs rarely are able to access individual drivers and their habits, and determine a customized remedial plan to meet each driver’s needs. Further, when actually providing feedback to their drivers, employers must remove them from the road and into classrooms or meeting rooms, where they are paid but not producing revenue or results.

As such, there is a continuing unmet need for a system that provides coaching opportunities to drivers that is customized for each driver to improve identified driver performance shortcomings in need of safety or improvement. Such a system should be able to ascertain potential areas for instruction of newly hired employees where little or no driving record is available.

Thereafter, such a system should enable the drivers to receive such individualized coaching with a minimal amount of time out of the driver’s seat, to better serve both the drivers and their employers.

The present invention provides a new and improved apparatus and method which addresses the above-referenced problems.

### SUMMARY

In one embodiment, a method of providing a driver of a vehicle with feedback for self-coaching, via a driver electronic device includes querying a server from access software on the driver electronic device. The querying comprises querying the server with a query comprising a predefined driver. The method also includes receiving, by the access software, driver coaching data associated with the predefined driver. The driver coaching data being based on an output from an active safety system on the vehicle. The method also includes listing, by the access software, a user-selectable item representing the received driver coaching data via a display of the driver electronic device. The method also includes conveying the driver coaching data to the driver.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1A illustrates a schematic representation of a system in accordance with one embodiment of an apparatus illustrating principles of the present invention;

FIG. 1B illustrates a schematic representation of a system in accordance with another embodiment of an apparatus illustrating principles of the present invention;

FIG. 2 is an exemplary methodology and workflow of providing a driver with feedback for self-coaching in accordance with one embodiment illustrating principles of the present invention;

FIG. 3 illustrates a representation of a screenshot of a monthly score and rank for providing a driver with feedback for self-coaching in accordance with one embodiment illustrating principles of the present invention;

FIG. 4 illustrates a representation of a screenshot of a daily score for providing a driver with feedback for self-coaching in accordance with one embodiment illustrating principles of the present invention;

FIG. 4A illustrates a representation of a screenshot of a daily score popup window for an event for providing a driver with feedback for self-coaching in accordance with one embodiment illustrating principles of the present invention;

FIG. 4B illustrates a representation of a screenshot of a daily score popup window for an event comment for providing a driver with feedback for self-coaching in accordance with one embodiment illustrating principles of the present invention;

FIG. 5 illustrates another representation of a screenshot of a daily score for providing a driver with feedback for self-coaching in accordance with one embodiment illustrating principles of the present invention; and

FIG. 5A illustrates another representation of a screenshot of a daily score popup window for an event for providing a driver with feedback for self-coaching in accordance with one embodiment illustrating principles of the present invention.

### DETAILED DESCRIPTION OF ILLUSTRATED EMBODIMENT

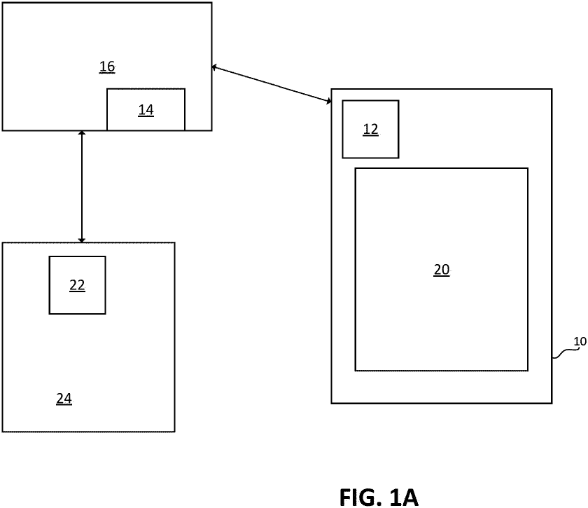

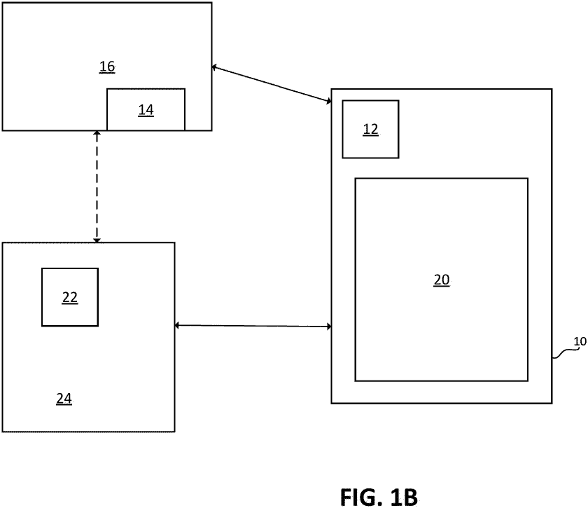

With reference to FIG. 1A, an electronic device 10 including access software 12 (e.g., an app), which is stored on the device 10, is illustrated for accessing driver coaching data 14 from a server 16 in accordance with one embodiment of the present invention. In the illustrated embodiment, the device 10 is a mobile device that executes the access software 12. For example, the access software 12 functions as an app on the device 10. The device 10 also includes an interactive display 20 that both displays information and, in one example, is a touchscreen that receives input from a user. In this embodiment, the app 12 functions as an extension of a web system, and the server 16 communicates with a processor 22 on a vehicle 24 via, for example, a cellular connection.

In an alternate embodiment (see FIG. 1B), the app 12 may be the only interface to the vehicle 24, and then has its own data repository in the cloud (e.g., for comparisons to other drivers, statistics, etc). The server 16 optionally communicates with the vehicle processor 22, which is indicated as a dashed line, via for example a cellular connection. In this embodiment, the app 12 communicates with the vehicle 24 (e.g., the vehicle processor 22) via e.g. a Bluetooth or Wi-Fi connection.

In one embodiment, the driver coaching data 14 is collected from, and based on, respective outputs from at least one active safety system (e.g., an antilock braking system (ABS), an electronic stability program (ESP) system, which may include a roll stability system and a jack-knife/yaw stability system, collision mitigation braking (CMB) system, etc.) on the vehicle 24.

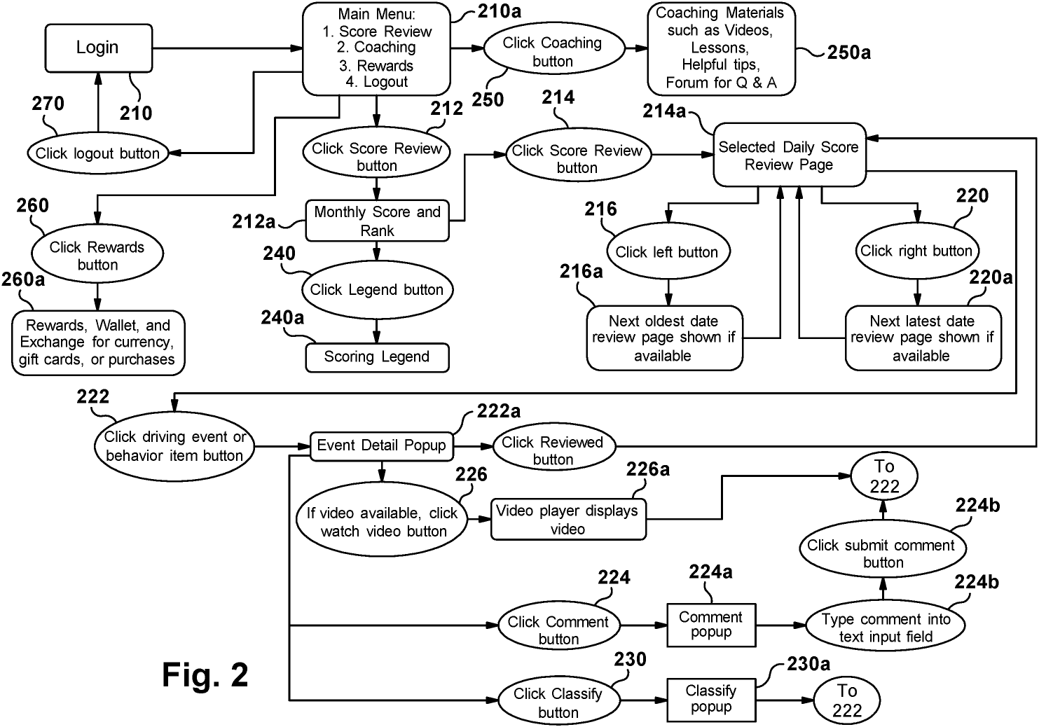

With reference to FIG. 2, a workflow of the access software 12 on the device 10 is illustrated. In a step 210, the user interacts with a login screen on the display 20 to login to the access software 12 (e.g., the app) as him/herself (e.g., as a predefined driver) . After logging in, a main menu 210a is displayed on the display 20, which prompts the user to select one of a plurality of different choices. In the illustrated embodiment, the choices displayed at 210a include: 1. Score Review; 2. Coaching; 3. Rewards; and 4. Logout.

If the user selects “1. Score Review″, in a step 212, control passes to 212a, which displays a monthly score and rank, for example, of the user. The score review section of the app is divided into daily pages. The most recent date of driving is the first page the driver is shown for review. As discussed below, the driver may navigate between pages by clicking the left or right buttons shown on the review pages. The left button is used to go to a prior date to the selected date while the right button is used to go to a more recent date. In one embodiment, the dates shown are only dates that the driver was on-duty and driving since off-duty days do not count.

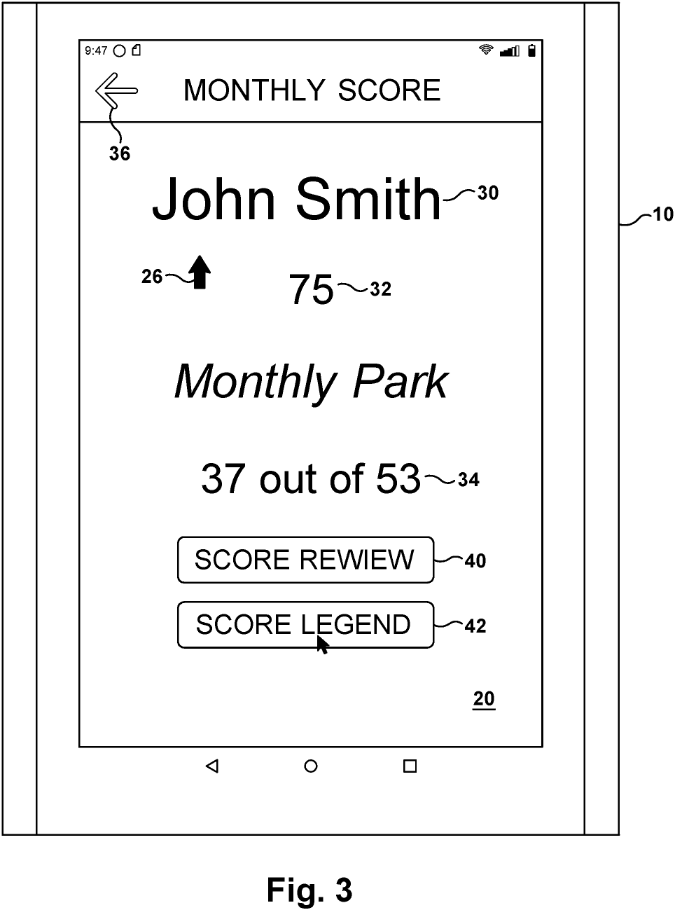

Each score review page displays the date, the daily score, optionally in a color-coding, with an optional icon 26 (see FIG. 3) to symbolize upward (e.g., blue up arrow), sideways (e.g., yellow warning triangle with exclamation point inside), or downward (e.g., red down arrow) score performance for their trend on that day versus their driving history, and a driver’s relevant driving behaviors and safety events for that day in a list or table with the accumulated score deductions per item. It is contemplated that the items are meaningfully color-coded and have unique icons that visually depict a legend indicator that is likely memorable to the driver. It is contemplated that a corresponding website also indicates the same icons whether within a map, a table, or another chart or graphic displayed on the backend website in order to keep the data and visuals consistent between the fleet managers and the drivers when reviewing.

With reference to FIGS. 2 and 3, a screenshot of the display 20 of the device 10 is shown when the workflow is at 212a. As illustrated in FIG. 3, the user’s name 30, driver coaching data 14 (e.g., the user’s monthly score 32 and the user’s monthly rank 34) are displayed. Whether the displayed score or rank compares the driver to the entire fleet of drivers or only drivers in a certain division may be a selectable option within the app. In another embodiment, a fleet manager may customize these and other settings in the app, via a limited access management section of a cloud access website, to define what drivers see and/or do in the app. In addition, three (3) interactive choices are presented to the user: a back arrow 36, a “Score Review” 40, and a “Score Legend” 42. If selected by the user, the back arrow 36 returns the display to the main menu displayed in the step 212.

Otherwise, if the “Score Review” 40 option is selected in a step 214, a daily score review page is displayed at 214a. The review items in the app are clickable buttons that when clicked, display an event detail pop-up with the event name, behavior name or fleet classification, a description or fleet comment, the score value of each occurrence of the behavior or event, and the count of the behavior or event for the selected date. Events with their own video may each have their own review item displayed while non-video events such as distance alerts may be summarized visually for simplicity. In one embodiment, events with video may be identified as more serious than non-video events. For example, as noted above distance alert events may be considered less serious than a CMB event and, therefore, distance alert events are non-video events while CMB events are video events. It is to be understood that whether an event is considered to be a non-video event or a video event may be customizable by a fleet manager.

In one embodiment, only non-video events are immediately available to a user of the app 12 on the electronic device 10, while video events must be first reviewed and, optionally, classified by a fleet manager, driver trainer or the like, before becoming available to the driver via the app 12 on the electronic device 10. Withholding video events from the app so that they are first reviewed by a fleet manager may be useful if, for example, the video event occurred around the time the vehicle 24 was involved in an accident. In that case, withholding a video event until it is reviewed by a fleet manager may prevent a driver from obtaining selected screenshots from the video, which don’t convey the entire story, in an attempt to exonerate him/herself.

Events with video may display a “Video Available” icon on their review item. Events that have missing video may have an icon displayed for “Video Not Yet Available” when they should have a video but no video files were available due to a potential vehicle safety system health or tampering issue. Each behavior or event pop-up has a “Reviewed” button that records the driver review of the item upon click. The review records are stored in a local datastore and synced with a remote datastore.

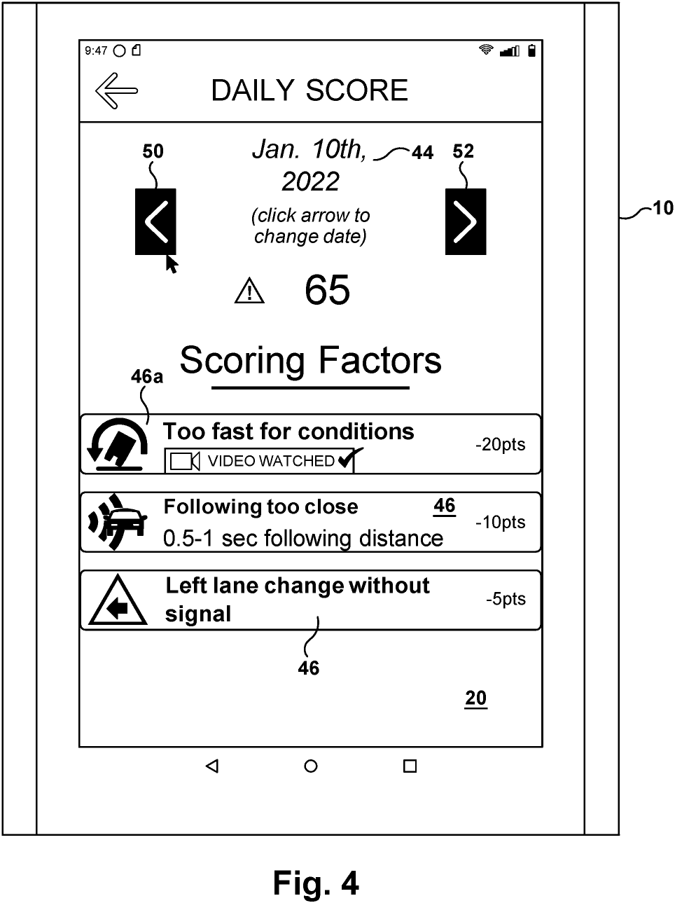

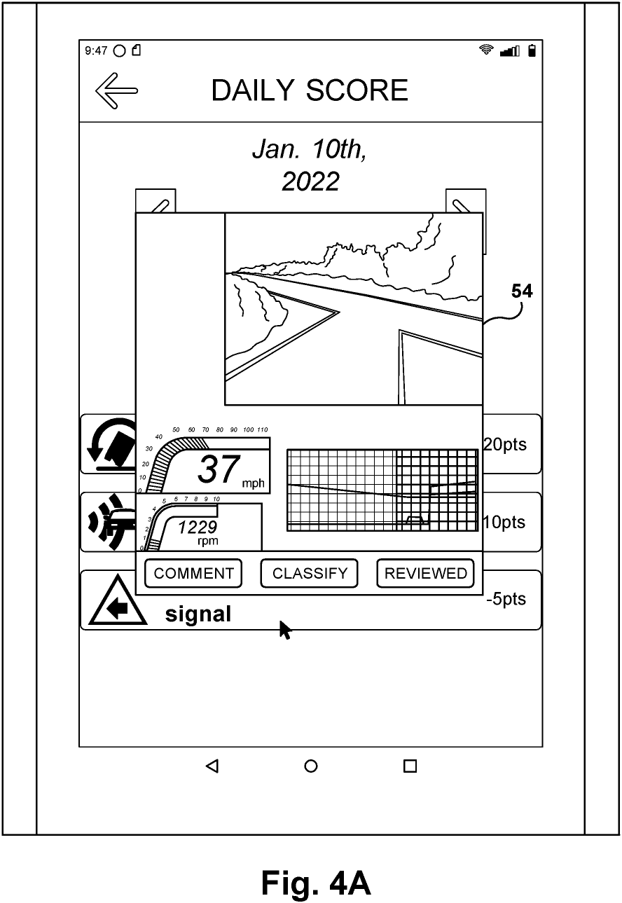

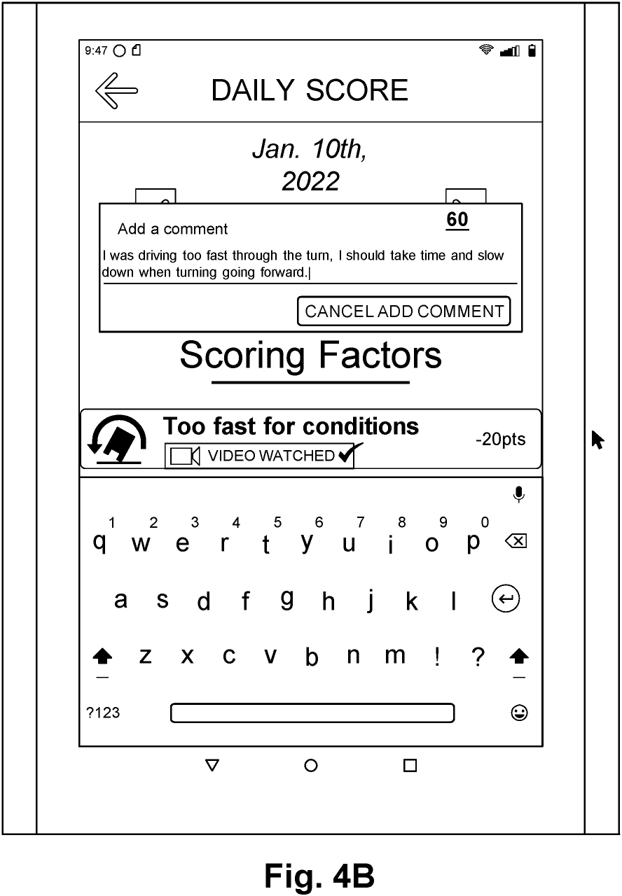

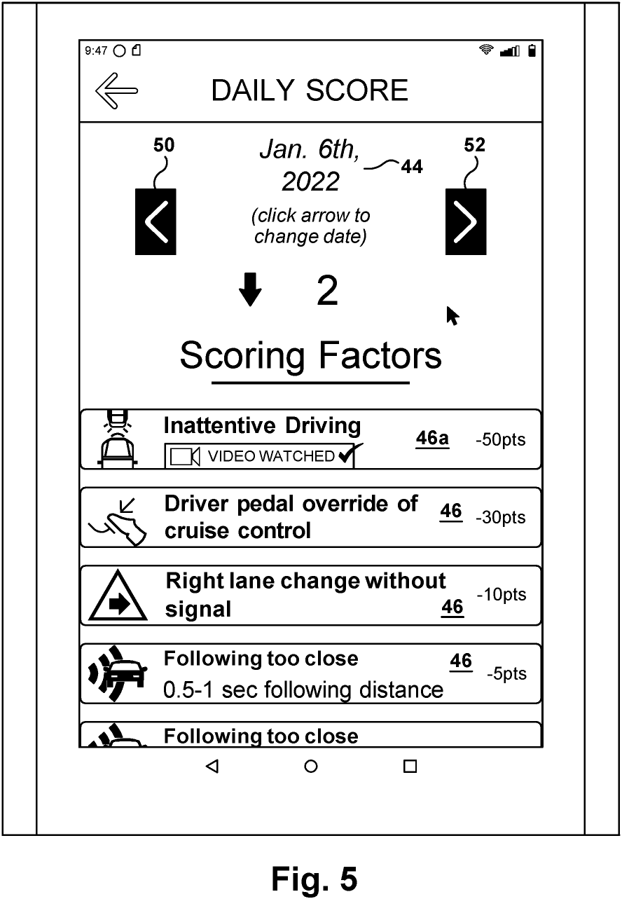

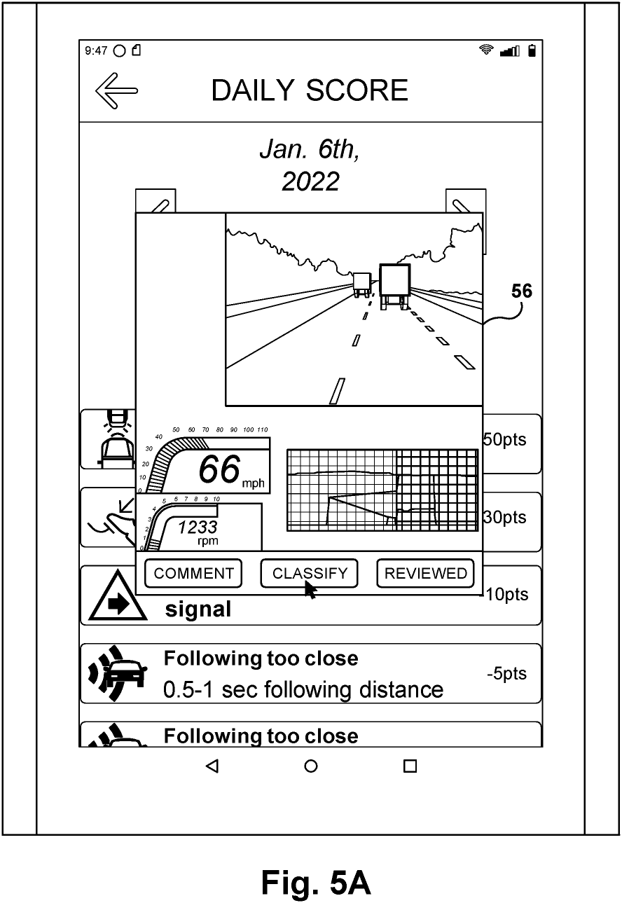

With reference to FIGS. 2 and 4, a screenshot of the display 20 of the device 10 is shown in one embodiment when the workflow at 214a. As illustrated in FIG. 4, the user’s daily score for a particular date 44 (e.g., Jan. 10, 2022) is illustrated at 214a. Events 46, 46a with descriptions and respective score deductions are also listed on the display 20 for the particular date 44. In one embodiment, the events 46 are considered non-video scored events (e.g., data only scored events) and the events 46a are considered video scored events. Left and right arrows 50, 52, respectively, on the display 20 allow the user to change dates in steps 216 and 220, respectively. For example, the user may touch the left arrow, in the step 216, until specific information for a previous particular date 44 (e.g., Jan. 6, 2022) is displayed on the display 20 (see FIG. 5). The information displayed after the steps 216 and 220 is shown in the workflow at 216a and 220a, respectively.

In a step 222, the user selects (e.g., touches) a particular event 46 or 46a on the display 20 in either FIGS. 4 or 5. FIGS. 4a and 5a illustrate specific details of a video event 46a selected in the step 222 in respective popup windows 54, 56 (see 222a in the workflow). Within the event detail pop-ups for video events with the video available icon, there may also be a “Watch Video” button if the event has a video present. The driver may click the watch video button, the app will download the video from the server 16 (e.g., a backend API, the on-vehicle processor 22, etc.), and the video will start playing automatically in a video player within the app. The video player may be contained within a popup the has a “Reviewed” button as well as a “Comment” button. The driver may click the comment button and type a comment in the text box and click the “Submit” button. If the driver does not add a comment, they may click the “Reviewed” button.

Reviewed item records with timestamps, driver comments, time spent reviewing, time spent commenting, and various other info collected from the driver’s activities such as video watched count, durations looking at any particular page or pop-up, number of clicks on certain types of items, etc. are captured locally in a datastore for some time and also may be synced over a network, such as Bluetooth, Wi-Fi, or the Internet to another, possibly cloud-based, remote datastore with, for example, a NoSQL architecture with fast and flexible mobile syncing. This information regarding how much time a driver spends reviewing these items, which correspond to driver coaching data 14, may be queried from the server 16 by fleet managers. The architecture must have off-line sync functionality so that data is collected and stored at least until it is sent over the network to the remote datastore.

In the embodiments of the popup windows illustrated in FIGS. 4a and 5a, the user can select, in a step 224, the “Comment” option, in which case a popup window 60 opens (see 224a in the workflow) for the user to type and submit an individual comment (e.g., a self-comment) at a step 224b; control then returns to the step 222. Alternatively at 222a, the user can select, in a step 226 the “Video” option (if video is available), in which case a video associated with the event 46 is displayed (see 226a in the workflow) to the user; control then returns to the step 222. Alternatively at 222a, the user can select, in a step 230 the “Classify” option, in which case a popup window opens (see 230a in the workflow) for the user to provide a user classification (e.g., a self-classification) of the event 46 (e.g., at-fault or not-at-fault); control then returns to the step 222. Once the user is done with the step 222, the user selects “Reviewed” in a step 232, which then returns control to 214a.

It is contemplated that the self-comment and/or self-classification are used for training an automated classification system. In this embodiment, the events that have been commented and/or classified by the user, possibly after manual or automated review, are used by an automated cloud-based classification system as one of possibly multiple sources for artificial intelligence (AI) training.

If the “Score Legend” 42 option is selected in a step 240, after 212a, control passes to 240a for displaying a score legend. The driver may click the “Legend” button to see a legend with color-coded icons representing different event types. The legend includes detailed and concise descriptions and the related point deductions for each event type or behavior. The score legend identifies different events 46 and respective point deductions. In one embodiment, each driver’s score begins at 100 each day, and points are then deducted based on different events. For example, a CMB event may “cost” the driver 50 points for that day (e.g., the CMB event results in a 50 point deduction for the driver that day). Therefore, if the driver had 100 points before the CMB event, that driver’s resulting score after the CMB event is 50 points (i.e., 100 points - 50 points). In this way, the score legend facilitates a driver’s understanding of his/her score. The user can then select a back button (not shown) to return control to 210a.

If the user selects “2. Coaching″ at 210a, control passes to a step 250 for displaying, on the display 20, the driver coaching data 14 (e.g., coaching materials including videos, lessons, helpful driving tips, a forum for questions and answers, etc.) (see 250a of the workflow). In one embodiment, the driver coaching data 14 is transferred from the server 16 to the app 12 in the electronic device 10. Training and coaching should likely be part of a commercial driver’s daily workflow tasks if it is needed to drive safely. This coaching option may act as providing feedback for self-coaching opportunities that vehicle drivers can use to improve their driving skills.

Control then returns control to 210a.

If the user selects “3. Rewards″ at 210a, control passes to a step 260 for displaying, on the display 20, rewards information for the driver (e.g., rewards, a wallet, exchange for currency, gift cards and/or purchases) (see 260a of the workflow). An exchange section is where a driver may redeem his/her reward points or cryptocurrency for another currency, gift cards, or other purchases such as at Amazon, etc.

The safe drivers who exhibit no or infrequent safety events with positive driving behaviors likely do not receive a phone call with a “thank you” for going out of their way to excel very often. These drivers have their eyes on the road, hands on the wheel, and the system barely even has to go off for them. They likely do not feel engaged with the rest of the fleet. They are underappreciated and could help the bad drivers excel with positive examples of driving behavior and maneuvers as well as well-earned advice. These drivers may be rewarded through the mobile app. They may be rewarded using a point system or a cryptocurrency, which may have a base value per unit and may be multiplied based on one or more factors such as the driver’s score or average score over a time period which may be variable, a positive behavior type exhibited such as defensive driving, SMITH driving maneuvers to avoid erratic traffic behavior such as to avoid cut off, aim-high steering, proper following distance of 2.8 seconds or greater to forward vehicle, using cruise control effectively and not overriding it with the accelerator pedal, driving cautiously in adverse weather conditions such as a blizzard to prevent stability or traction control from kicking in, driving slower around turns to prevent rollover, taking less sharp turns to prevent jack-knife, etc.

The safe drivers could participate in teams with the risky drivers through the mobile app which allows them to mentor other drivers and allows for driver and team achievements to be met. Teams could compete against each other for rewards or achievements or titles with the division or across the fleet or even across all customers using the embodied solution, i.e. a cross fleet comparison or leaderboard. There may be a performance leaderboard to highlight team-wide, division-wide, fleet-wide, or cross-fleet performance for similar types of drivers to compare themselves and their progress. If an entire team of drivers is improving, they may all be rewarded their fair share of points or crypto. If one driver in particular is improving more so than the rest on a team, that driver might be able to win the entire share of the reward for the team due to their outstanding performance. The mentors would in turn win some sort of reward for helping improve their risky driver mentees through this program. Teams could also be offered rewards for completing certain achievements overtime such as continuing to consistently be the highest scoring and ranking team at the fleet or even across all fleets using the embodied solution.

One embodiment of the present invention will help gamify the daily work of truck driving and will help attract and retain a wide spectrum of drivers, both talented and inexperienced, who are proficient with a smart phone. This will open up new financial opportunities for commercial drivers and provide them incentives to be safer drivers who follow the rules. The app will gamify safe and defensive driving behavior. This solution will help promote safer roads across North America and beyond and hopefully help reduce risk in commercial driver hiring and employment going forward.

If there is an upward trend in a driver’s performance with or without use of the app, the driver could be positively alerted and rewarded using the disclosed reward system. If there is a downward trend in performance, the driver could be negatively alerted and rewards may be subtracted as well as requiring some lesson which may include watching coaching videos, getting mentored by a safe driver, or completing lesson modules that may include mini-lessons and quizzes. These lessons could be required for them to complete in addition to their normal workflow before they are allowed to drive again on their next shift, etc. Their progress on in these lessons will also be captured to the local datastore and may be synced with remote datastore over network such as Internet, etc.

Control then returns control to 210a. The user can select “Logout” in a step 270.

A corresponding website that displays the driver risk score trends per division or group is also contemplated. The website may display tables including driver behaviors or events, categorical labels, comments, associated point deductions, etc. As mentioned earlier, the site may display a map with icons consistent with the driver app icons for behaviors and events. The map icons may be clickable and display hover-over popups that show event or behavior name, description or fleet comments, score(s), timestamp of item(s), location name of item(s), driver name(s) related to event or behavior, vehicle id(s), trailer id(s), etc. The map icons may also filter a video player on a corresponding webpage that selects the event video displayed based on the map icon clicked and if there is a video available.

One or more score charts with score plots and trend lines may be displayed that highlight top-ranking drivers, bottom-ranking drivers, division score trends, fleet overall score trends, and show the moving average trend and direction over time, etc.

Driver app review records including driver comments sent to a cloud datastore may be shown to the fleet safety teams in the website. This would give the fleets the ability to get direct safety feedback from their drivers in near real-time. This review data could be used to showcase driver improvement by means of their score and behavior trends correlated with the amount of time spent reviewing certain items in the app over time. The data could be used to automatically help keep certain risky drivers in check by auto-alerting them and suggesting lessons from within the app 12 and continuously tracking their progress in a feedback loop between the fleet safety team, the driver, and the driver responses to the coaching lessons and materials, fleet commentary, etc.

In one embodiment, the access software 12 is stored on a non-transitory computer-readable medium. In this way, the non-transitory computer-readable medium has instructions stored thereon for providing a driver of the vehicle 24 with feedback for self-coaching. The instructions of the access software 12, which are stored is a non-transitory computer-readable medium, when executed by computer, cause steps to be performed for at least querying, transferring, receiving and listing different aspects of the driver coaching data 14.

A driver risk profile may be built by accumulating driver safety system event information and other related driver data collected from the aforementioned driver app such as driver review records, taken or ignored coaching opportunities or lessons, completed lessons and correlated performance trend improvement. or third party providers such as OEMs, telematics providers. The data can be kept in a secure database or blockchain. The data may be accessed upon request by third parties with the approval of the driver under review.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant’s general inventive concept.

I/We claim:

1. A method of providing a driver of a vehicle with feedback for self-coaching, via a driver electronic device, the method comprising:
querying a server from access software on the driver electronic device, wherein the querying comprises querying the server with a query comprising a predefined driver;
receiving, by the access software, driver coaching data associated with the predefined driver, the driver coaching data being based on an output from a sensor on the vehicle; and
listing, by the access software, a user-selectable item representing the received driver coaching data via a display of the driver electronic device; and
conveying the driver coaching data to the driver.

2. The method of providing a driver of a vehicle with feedback for self-coaching as set forth in claim 1, wherein the method further includes:
in response to receiving the selection of the user-selectable item, initiating a transfer of the coaching data from the server to the driver electronic device.

3. The method of providing a driver of a vehicle with feedback for self-coaching as set forth in claim 2, wherein the method further includes:
displaying, via the display, the driver coaching data as a score of the predefined driver.

4. The method of providing a driver of a vehicle with feedback for self-coaching as set forth in claim 3, wherein the method further includes:
displaying, via the display, the score of the predefined driver as a monthly score.

5. The method of providing a driver of a vehicle with feedback for self-coaching as set forth in claim 2, wherein the method further includes:
displaying, via the display, the driver coaching data as a rank of the predefined driver.

6. The method of providing a driver of a vehicle with feedback for self-coaching as set forth in claim 5, wherein the method further includes:
displaying, via the display, the rank of the predefined driver as a comparison of the rank of the driver to respective ranks stored in the server of other drivers.

7. The method of providing a driver of a vehicle with feedback for self-coaching as set forth in claim 1, wherein the method further includes:
querying the remote server from a fleet manager electronic device, wherein the querying comprises querying the remote server with a query comprising the predefined driver and an associated review time as parameters, the associated review time indicating a time that the predefined driver views the driver coaching data.

8. The method of providing a driver of a vehicle with feedback for self-coaching as set forth in claim 1, wherein the querying step includes:
querying the server, which is remote from the vehicle, from the access software on the electronic device.

9. The method of providing a driver of a vehicle with feedback for self-coaching as set forth in claim 1, wherein the querying step includes:
querying the server, which is a processor on the vehicle, from the access software on the electronic device.

10. The method of providing a driver of a vehicle with feedback for self-coaching as set forth in claim 1, wherein the querying step includes:
querying the server with a query comprising an assignment of the predefined driver.

11. The method of providing a driver of a vehicle with feedback for self-coaching as set forth in claim 1, further including:
receiving the output of the sensor by an active safety system;
determining an output of the active safety system based on the output received from the sensor; and
determining the driver coaching data based on the output from the active safety system.

12. The method of providing a driver of a vehicle with feedback for self-coaching as set forth in claim 11, wherein the step of receiving the output of the sensor includes:
receiving the output of the sensor by an antilock braking system active safety system on the vehicle.

13. The method of providing a driver of a vehicle with feedback for self-coaching as set forth in claim 1, further including:
receiving, by the access software, a user selection of a user of the user-selectable item.

14. A non-transitory computer-readable medium, having instructions stored thereon for providing a driver of a vehicle with feedback for self-coaching, the instructions, when executed by a computer, cause the computer to perform the steps comprising:
querying a server from access software on a driver electronic device, wherein the querying comprises querying the server with a query comprising a predefined driver;
receiving, by the access software, driver coaching data associated with the predefined driver, the driver coaching data being based on an output from a sensor on the vehicle; and
listing, by the access software, a user-selectable item representing the received driver coaching data via a display of the driver electronic device; and
conveying the driver coaching data to the driver.

15. The non-transitory computer-readable medium as set forth in claim 14, the instructions, when executed by a computer, cause the computer to perform the step comprising:
in response to receiving the selection of the user-selectable item, initiating a transfer of the coaching data from the server to the driver electronic device.

16. The non-transitory computer-readable medium as set forth in claim 15, the instructions, when executed by a computer, cause the computer to perform the step comprising:
displaying, via the display, the driver coaching data as a score of the predefined driver.

17. The non-transitory computer-readable medium as set forth in claim 16, the instructions, when executed by a computer, cause the computer to perform the step comprising:
displaying, via the display, the score of the predefined driver as a monthly score.

18. The non-transitory computer-readable medium as set forth in claim 15, the instructions, when executed by a computer, cause the computer to perform the step comprising:
displaying, via the display, the driver coaching data as a rank of the predefined driver.

19. The non-transitory computer-readable medium as set forth in claim 18, the instructions, when executed by a computer, cause the computer to perform the step comprising:
displaying, via the display, the rank of the predefined driver as a comparison of the rank of the driver to respective ranks stored in the server of other drivers.

20. The non-transitory computer-readable medium as set forth in claim 14, the instructions, when executed by a computer, cause the computer to perform the step comprising:
querying the remote server from a fleet manager electronic device, wherein the querying comprises querying the remote server with a query comprising the predefined driver and an associated review time as parameters, the associated review time indicating a time that the predefined driver views the driver coaching data.

21. The non-transitory computer-readable medium as set forth in claim 14, the instructions, when executed by a computer, cause the computer to perform the step comprising:
querying the server, which is remote from the vehicle, from the access software on the electronic device.

22. The non-transitory computer-readable medium as set forth in claim 14, the instructions, when executed by a computer, cause the computer to perform the step comprising:
querying the server, which is a processor on the vehicle, from the access software on the electronic device.

23. The non-transitory computer-readable medium as set forth in claim 14, the instructions, when executed by a computer, cause the computer to perform the step comprising:
querying the server with a query comprising an assignment of the predefined driver.

24. The non-transitory computer-readable medium as set forth in claim 14, the instructions, when executed by a computer, cause the computer to perform the steps comprising:
receiving the output of the sensor by an active safety system;
determining an output of the active safety system based on the output received from the sensor; and
determining the driver coaching data based on the output from the active safety system.

25. The non-transitory computer-readable medium as set forth in claim 14, the instructions, when executed by a computer, cause the computer to perform the step comprising:
receiving the output of the sensor by an antilock braking system active safety system on the vehicle.

26. The non-transitory computer-readable medium as set forth in claim 14, the instructions, when executed by a computer, cause the computer to perform the step comprising:
receiving, by the access software, a user selection of a user of the user-selectable item.
